(19) United States
(12) Patent Application Publication
(10) Pub. No.: US 2024/0296158 A1
(43) Pub. Date: Sep. 5, 2024

(54) MANAGEMENT METHOD, DEVICE, AND RECORDING MEDIUM

(71) Applicant: Panasonic Intellectual Property Corporation of America, Torrance, CA (US)

(72) Inventor: Ayaka NAKASAKA, Osaka (JP)

(21) Appl. No.: 18/658,254

(22) Filed: May 8, 2024

Related U.S. Application Data
(63) Continuation of application No. PCT/JP2022/041803, filed on Nov. 10, 2022.
(60) Provisional application No. 63/280,812, filed on Nov. 18, 2021.

(51) Int. Cl. G06F 16/23

(52) U.S. Cl. CPC G06F 16/2379

(57) ABSTRACT

A management method is performed by one of a plurality of devices each holding a distributed ledger for managing a record of a consumption process in which a plurality of users consume a resource. The management method includes: when a first user performs at least one of (i) consuming a first amount of a resource or (ii) handing a second amount of a resource over to a second user, storing, into the distributed ledger, first transaction data including a record of at least one of the consumption and the handover; when there is a loss of the resource that is left unconsumed by the plurality of users upon an expiration limit, calculating a retention period indicating a period for which the first user has held the resource; and calculating a retention value of the first user that is included in a retention index, and outputting the retention value calculated.

### CROSS REFERENCE TO RELATED APPLICATIONS

This is a continuation application of PCT International Application No. PCT/JP2022/041803 filed on Nov. 10, 2022, designating the United States of America, which is based on and claims priority of U.S. Provisional Patent Application No. 63/280,812 filed on Nov. 18, 2021. The entire disclosures of the above-identified applications, including the specifications, drawings and claims are incorporated herein by reference in their entirety.

### FIELD

The present disclosure relates to management methods, devices, and recording media.

### BACKGROUND

Patent Literature (PTL) 1 discloses a technique for managing food distribution using distributed ledgers.

### CITATION LIST

### Patent Literature

PTL 1: Japanese Unexamined Patent Application Publication No. 2019-79253

### SUMMARY

### Technical Problem

An object of the present disclosure is to provide a management method, etc., that can reduce the amount of data traffic while reducing loss of resources with expiration limits, such as food products, which is the remaining amount of the resources that are left unconsumed.

### Solution to Problem

A management method according to one aspect of the present disclosure is performed by one of a plurality of devices included in a management system and each holding a distributed ledger for managing a record of a consumption process in which a plurality of users including a first user and a second user consume a resource with an expiration limit. The management method includes: storing first transaction data into the distributed ledger when the first user performs at least one of (i) consuming a first amount of a resource out of a predetermined amount of a resource with an expiration limit or (ii) handing a second amount of a resource out of the predetermined amount of the resource over to the second user, the first transaction data including a record of the at least one of the consumption and the handover by the first user; when a loss of the resource is found, calculating a retention period by referring to the distributed ledger, the loss of the resource being a remaining amount of a resource left unconsumed by the plurality of users upon the expiration limit out of the predetermined amount of the resource, the retention period indicating a period for which the first user has held the resource; and calculating a retention value of the first user based on the retention period, and outputting the retention value calculated, the retention value being included in a retention index which is an index indicating involvement in retention of the resource.

Note that these general and specific aspects may be implemented using a system, a device, an integrated circuit, a computer program, or a computer-readable recording medium such as a compact disc read-only memory (CD-ROM), or any combination of systems, devices, integrated circuits, computer programs, and recording media.

### Advantageous Effects

The present disclosure can lead to a reduction in the amount of data traffic, loss, and the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating one example of the configuration of a management system according to an exemplary embodiment.

FIG. 2 is a diagram illustrating one example of the configuration of an information terminal according to an exemplary embodiment.

FIG. 3 is a diagram illustrating one example of the configuration of a server according to an exemplary embodiment.

FIG. 4 is a diagram illustrating the amount and period of a resource consumed or handed over by each user.

FIG. 5 is a sequence chart illustrating one example of the operation of a management system according to an exemplary embodiment.

FIG. 6 is a diagram illustrating one example of the configuration of a management system according to Variation 1.

FIG. 7 is a diagram illustrating one example of the configuration of a device according to Variation 1.

FIG. 8 is a diagram illustrating the amount and period of a resource consumed or handed over by each device.

FIG. 9 is a sequence chart illustrating one example of the operation of a management system according to Variation 2.

### DESCRIPTION OF EMBODIMENT

The management method according to the first aspect of the present disclosure is performed by one of a plurality of devices included in a management system and each holding a distributed ledger for managing a record of a consumption process in which a plurality of users including a first user and a second user consume a resource with an expiration limit. The management method includes: storing first transaction data into the distributed ledger when the first user performs at least one of (i) consuming a first amount of a resource out of a predetermined amount of a resource with an expiration limit or (ii) handing a second amount of a resource out of the predetermined amount of the resource over to the second user, the first transaction data including a record of the at least one of the consumption and the handover by the first user; when a loss of the resource is found, calculating a retention period by referring to the distributed ledger, the loss of the resource being a remaining amount of a resource left unconsumed by the plurality of users upon the expiration limit out of the predetermined amount of the resource, the retention period indicating a period for which the first user has held the resource; and calculating a retention value of the first user based on the retention period, and outputting the retention value calculated, the retention value being included in a retention index which is an index indicating involvement in retention of the resource.

Conventional resource management is centrally operated with an enterprise resource planning (ERP) system for each company, meaning that communication with the system for each company is required to calculate a retention period, a level of involvement in the loss, or the like among supply chains, which leads to an increase in the amount of data traffic.

According to the first aspect of the present disclosure, a retention value in a retention index which is an index indicating involvement of the first user in retention of a resource, in other words, a retention value serving as an evaluation value for retention of a resource by the first user, is calculated, and the retention value is output. A large retention value is likely to lead to significant loss; therefore, the retention value of the first user can be regarded as a level of involvement of the first user, among the plurality of users who have involved in the handover of the resource, in the loss that has occurred. This means that the level of involvement of the first user in the loss can be calculated by calculating the retention value of the first user. Thus, the retention value, the level of involvement in the loss, or the like can be calculated without communication with the system for each company, allowing for a reduction in the amount of data traffic. Furthermore, for example, by applying measures to the first user such as imposing on the first user a penalty that corresponds to the retention value, it is possible to prompt the first user to quickly consume or hand over the resource so that the retention value is reduced. Thus, there is a possibility that the loss can be reduced.

The management method according to the second aspect of the present disclosure is the management method according to the first aspect that further includes calculating the loss of the resource by referring to the distributed ledger when the expiration limit is reached. The retention value is calculated based on the loss of the resource and the retention period.

With this, it is possible to determine a retention value corresponding to the loss that has occurred. Therefore, for example, when two or more different losses occur, it is possible to determine respective retention values corresponding to said losses.

The management method according to the third aspect of the present disclosure is the management method according to the second aspect that further includes determining, according to an ordinal number in a sequence of the plurality of users to whom the predetermined amount of the resource has been handed over, a weight for each of the plurality of users who has obtained at least a part of the predetermined amount of the resource. The retention value is calculated based on the weight determined for the first user, the loss, and the retention period.

Therefore, it is possible to determine a retention value according to an ordinal number in the sequence of the handover.

The management method according to the fourth aspect of the present disclosure is the management method according to the third aspect in which the weight is determined to be greater as the ordinal number increases.

Therefore, it is possible to make later participation in the process of consuming the resource more difficult, meaning that a user who is not capable of consuming the resource until the expiration limit can be kept from receiving the resource.

The management method according to the fifth aspect of the present disclosure is the management method according to the third aspect in which the weight is determined to be greater as the ordinal number decreases.

Therefore, it is possible to facilitate later participation of many users in the process of consuming the resource, meaning that a larger amount of the resource may be consumed by users who have participated later; thus, there is a possibility that the occurrence of loss can be reduced.

The management method according to the sixth aspect of the present disclosure is the management method according to any one of the first aspect to the fifth aspect that further includes: determining a greater token for a higher level of the involvement in the retention of the resource that is indicated by the retention value; and collecting the token from the first user.

Accordingly, a penalty that corresponds to the retention value can be imposed on the first user, meaning that it is possible to prompt the first user to quickly consume or hand over the resource so that the retention value is reduced. Thus, there is a possibility that the loss can be reduced.

The management method according to the seventh aspect of the present disclosure is the management method according to any one of the first aspect to the sixth aspect in which a first smart contract is stored in the distributed ledger, the first smart contract being a smart contract for performing a process of adding 1 to a latest ordinal number in a sequence of the handover of the predetermined amount of the resource, the latest ordinal number being specified by referring to the distributed ledger, and the first smart contract is executed when the first transaction data is stored.

Therefore, the ordinal number in the sequence can be automatically determined.

The management method according to the eighth aspect of the present disclosure is the management method according to the seventh aspect in which the first smart contract is a smart contract for further performing a process of determining whether a timestamp included in the first transaction data is beyond the expiration limit.

Therefore, whether the expiration limit has passed can be determined every time the first transaction data is stored into the distributed ledger.

The management method according to the ninth aspect of the present disclosure is the management method according to any one of the first aspect to the eighth aspect in which a second smart contract for calculating the retention period and the retention value is further stored in the distributed ledger, and the second smart contract is executed when second transaction data is stored into the distributed ledger, the second transaction data including expiry information indicating that the expiration limit has been reached.

Therefore, when the expiration limit is reached, the second smart contract allows for automatic calculation of the retention amount, the retention period, and the retention value.

The management method according to the tenth aspect of the present disclosure is the management method according to any one of the first aspect to the ninth aspect in which the resource of the predetermined amount is an object that deteriorates over time and when the expiration limit is exceeded, loses a predetermined function.

The management method according to the eleventh aspect of the present disclosure is the management method according to any one of the first aspect to the tenth aspect in which the resource of the predetermined amount is a logical resource that expires when the expiration limit is exceeded.

The management method according to the twelfth aspect of the present disclosure is the management method according to any one of the first aspect to the eleventh aspect in which the retention value is calculated for each of the plurality of users.

Therefore, the plurality of users can be evaluated, and a user having a small retention value can be evaluated as a reliable user. When the reliability of users improves, it is possible to provide an environment (system) that is user-friendly for reliable users.

The device according to the thirteenth aspect of the present disclosure is one of a plurality of devices included in a management system and each holding a distributed ledger for managing a record of a consumption process in which a plurality of users including a first user and a second user consume a resource with an expiration limit. The device includes: storage that stores first transaction data into the distributed ledger when the first user performs at least one of (i) consuming a first amount of a resource out of a predetermined amount of a resource with an expiration limit or (ii) handing a second amount of a resource out of the predetermined amount of the resource over to the second user, the first transaction data including a record of the at least one of the consumption and the handover by the first user; a calculator that when a loss of the resource is found, calculates a retention period by referring to the distributed ledger, the loss of the resource being a remaining amount of a resource left unconsumed by the plurality of users upon the expiration limit out of the predetermined amount of the resource, the retention period indicating a period for which the first user has held the resource; and an outputter that calculates a retention value of the first user based on the retention period, and outputs the retention value calculated, the retention value being included in a retention index which is an index indicating involvement in retention of the resource.

With this, a retention value in a retention index which is an index indicating involvement of the first user in retention of a resource, in other words, a retention value serving as an evaluation value for retention of a resource by the first user, is calculated, and the retention value is output. A large retention value is likely to lead to significant loss; therefore, the retention value of the first user can be regarded as a level of involvement of the first user, among the plurality of users who have involved in the handover of the resource, in the loss that has occurred. This means that the level of involvement of the first user in the loss can be calculated by calculating the retention value of the first user. Accordingly, for example, by applying measures to the first user such as imposing on the first user a penalty that corresponds to the retention value, it is possible to prompt the first user to quickly consume or hand over the resource so that the retention value is reduced. Thus, there is a possibility that the loss can be reduced.

The recording medium according to the fourteenth aspect of the present disclosure is a non-transitory computer-readable recording medium having stored thereon a program for causing a computer to execute the management method according to any one of the first aspect to the twelfth aspect.

Note that these general and specific aspects may be implemented using a system, a device, an integrated circuit, a computer program, or a computer-readable recording medium such as a compact disc read-only memory (CD-ROM), or any combination of systems, devices, integrated circuits, computer programs, and recording media.

Hereinafter, an exemplary embodiment will be described with reference to the drawings. Note that each exemplary embodiment described below shows one specific example of the present disclosure. In other words, the numerical values, shapes, materials, structural elements, the arrangement and connection of the structural elements, steps, the processing order of the steps etc., shown in the following exemplary embodiment are mere examples, and are not intended to limit the present disclosure. Therefore, among the structural elements in the following exemplary embodiment, structural elements not recited in any one of the independent claims are not necessarily required to achieve the object of the present disclosure, but are described as structural elements of a more preferred exemplary embodiment.

### Exemplary Embodiment

First, a system configuration according to the present disclosure will be described.

Hereinafter, the configuration, etc., of a management system according to the present exemplary embodiment will be described with reference to the drawings.

### [Management System]

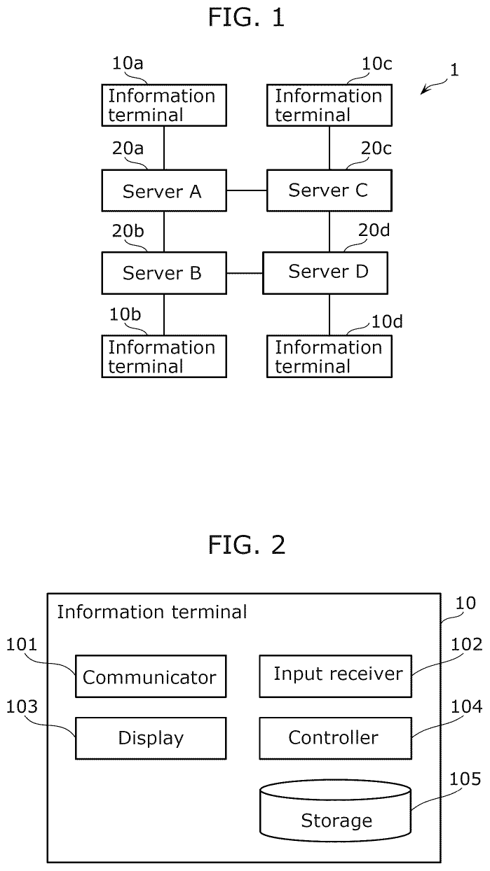

FIG. 1 is a diagram illustrating one example of the configuration of the management system according to the exemplary embodiment.

Management system 1 according to the present disclosure includes, for example, a plurality of information terminals 10a to 10d and a plurality of servers 20a to 20d, as illustrated in FIG. 1. These are connected via a network not illustrated in the drawings. The network, which is the Internet or a cell-phone carrier network, for example, may include any communication line or network. Information terminal 10a is a terminal that receives input from a first user, information terminal 10b is a terminal that receives input from a second user, information terminal 10c is a terminal that receives input from a third user, and information terminal 10d is a terminal that receives input from a fourth user.

Server 20a exchanges information with information terminal 10a, server 20b exchanges information with information terminal 10b, server 20c exchanges information with information terminal 10c, and server 20d exchanges information with information terminal 10d. Note that each of information terminals 10a to 10d may exchange information with a server different from the corresponding server.

Note that in the following description, each of information terminals 10a to 10d will also be referred to as information terminal 10, and information terminals 10a to 10d may also be referred to as information terminals A to D. Similarly, each of servers 20a to 20d will also be referred to as server 20, and servers 20a to 20d may also be referred to as servers A to D.

Management system 1 is a system that manages records of consumption processes in which the plurality of users consume resources. Management system 1 manages the records of consumption processes using distributed ledgers. In other words, management system 1 has distributed ledgers for managing the records of consumption processes.

The consumption processes are processes in which resources are consumed, including, for example, processes in which the first user obtains a resource and hands over a part or the whole of the resource to the second user, the first user consumes a part of the whole of the resource, and the second user hands over, to the third user, the resource obtained from the first user. In other words, the records of consumption processes include resource handover from one user to another and resource consumption by one user. The records of consumption processes include the amount of a resource that has been handed over, the date and time when a resource was handed over, a source user, and a destination user, for example. Furthermore, the records of consumption processes include the amount of a resource that has been consumed, the date and time when a resource was consumed, and a user who consumed a resource, for example. The handover refers to movement of a resource from one user to another. The consumption refers to the action of losing at least a part of a resource through use by one user.

The resource is an item or right that loses its value unless consumed until an expiration limit. When the value of the resource is lost, the resource is discarded or invalidated, for example. For example, the resource may be an object that deteriorates over time and when the expiration limit is exceeded, loses a predetermined function. The resource in this case is a food or a product, for example. Alternatively, the resource may be, for example, a logical resource that expires when the expiration limit is exceeded. The resource in this case is the amount of electricity scheduled to be used, the amount of emissions trading, or a ticket, for example. The ticket may be an event participation ticket or may be a ride ticket, for example.

### [Information Terminal 10]

Information terminal 10 receives input from a user, generates transaction data corresponding to the input, and transmits the transaction data to servers 20a to 20d. For example, information terminal 10 receives, from a user, input indicating that the user has obtained a predetermined amount of a resource, and generates transaction data including information indicating that the user holds the predetermined amount of the resource obtained. Furthermore, information terminal 10 may receive, from a user, input indicating that the user has consumed a first amount of a resource, and generate transaction data including information indicating that the first amount of the resource has been consumed, for example. Moreover, information terminal 10 may receive, from a user, input indicating that the user has handed over a second amount of the resource to another user, and generate transaction data including information indicating that the second amount of the resource has been handed over to another user, for example. In this manner, information terminal 10 generates first transaction data including a record of at least one of consumption and handover of a resource by a user. The transaction data for each transaction includes at least: a timestamp indicating when input is received; and a digital signature of information terminal 10 that has generated the transaction data. The transaction data for each transaction may include two or more different signatures such as the signatures of resource sender 10a and resource recipient 10b among information terminals 10. The digital signature is obtained by signing the hash of information included in transaction data using a signature key. This makes it possible to securely exchange information between computers. The digital signature may have been held by information terminal 10 in advance or may be obtained from server 20 when input from a user is received. Server 20 may keep the signature key of information terminal 10 so that server 20 can sign on behalf of information terminal 10.

FIG. 2 is a diagram illustrating one example of the configuration of the information terminal according to the exemplary embodiment.

Information terminal 10 includes communicator 101, input receiver 102, display 103, controller 104, and storage 105.

Communicator 101 transmits information to server 20 via the network and receives information from server 20 via the network, for example. The information that is transmitted to server 20 is, for example, transaction data generated by information terminal 10. The information that is received from server 20 is, for example, information (notification) indicating that a penalty token has been imposed on the user of said information terminal 10. Every time transaction data is generated, communicator 101 transmits the generated transaction data to server 20.

In this manner, communicator 101 communicates with servers 20a to 20d via the network. Note that this communication may be performed using transport layer security (TLS) and a cryptographic key for TLS communication may be held in communicator 101.

Input receiver 102 receives information input from a user. Input receiver 102 displays the received information input on display 103, transmits the received information input to controller 104, and transmits the received information input to communicator 101, for example.

In the present exemplary embodiment, by an operation performed by a user, input receiver 102 receives input indicating that the user has obtained the predetermined amount of a resource, input indicating that the user has consumed the first amount of the resource, and input indicating that the user has handed over the second amount of the resource to another user, for example. Input receiver 102 transmits the received input to controller 104. Furthermore, by an operation performed by the user, input receiver 102 may receive information indicating that the notification displayed on display 103 has been confirmed.

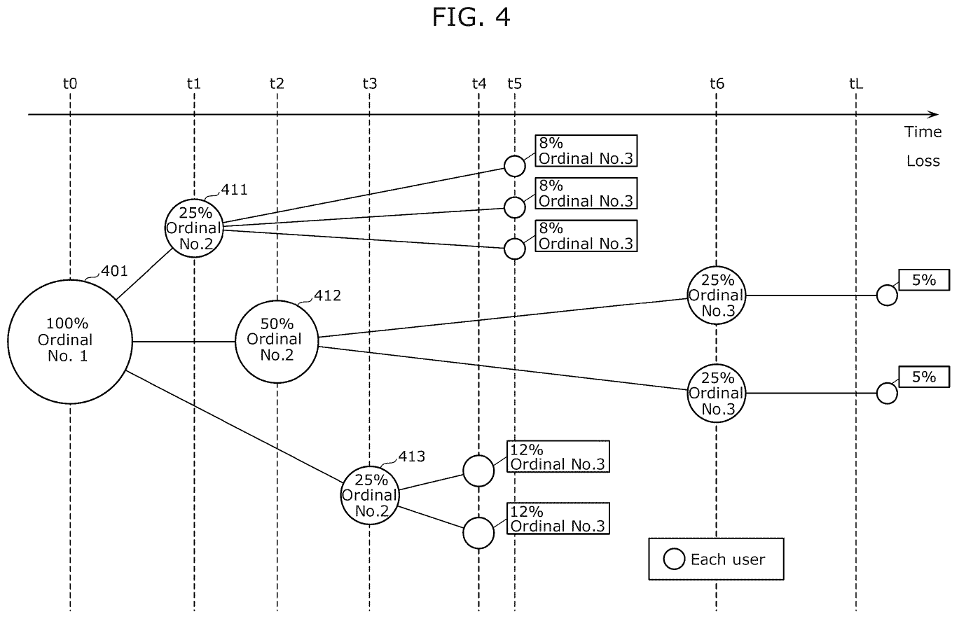

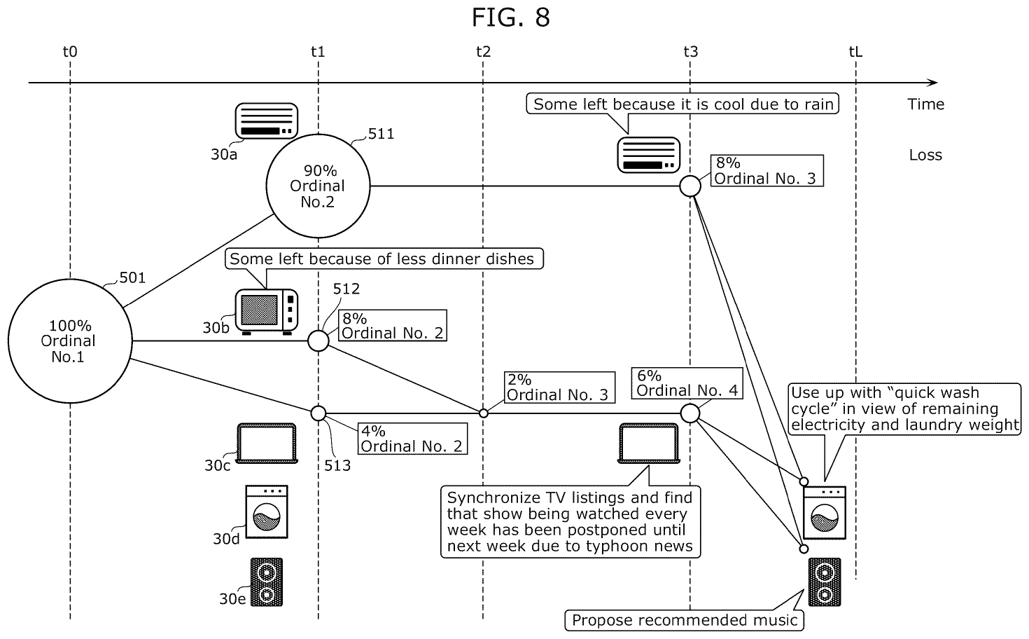

Display 103 displays a user interface (UI) for receiving input using input receiver 102. Furthermore, display 103 displays, in the UI, the information input received by input receiver 102. Display 103 may display the information reported from server 20. Furthermore, display 103 may display a part or the whole of the diagram illustrated in FIG. 4 or FIG. 8.

Controller 104 generates transaction data on the basis of the information input received by input receiver 102, and transmits the generated transaction data to server 20 via communicator 101. The transaction data is, for example, the first transaction data mentioned above or second transaction data. The second transaction data is transaction data including expiry information indicating that the expiration limit has been reached. For example, controller 104 generates the first transaction data and transmits the generated first transaction data to server 20. Furthermore, for example, controller 104 generates the second transaction data and transmits the generated second transaction data to server 20. Note that controller 104 may generate the second transaction data when the expiration limit is reached.

Storage 105 stores the information received by communicator 101, the input received by input receiver 102, and the transaction data generated by controller 104, for example. Data other than said information may be stored in storage 105.

Information terminal 10 can be realized by a processor performing a predetermined program using memory.

### [Server 20]

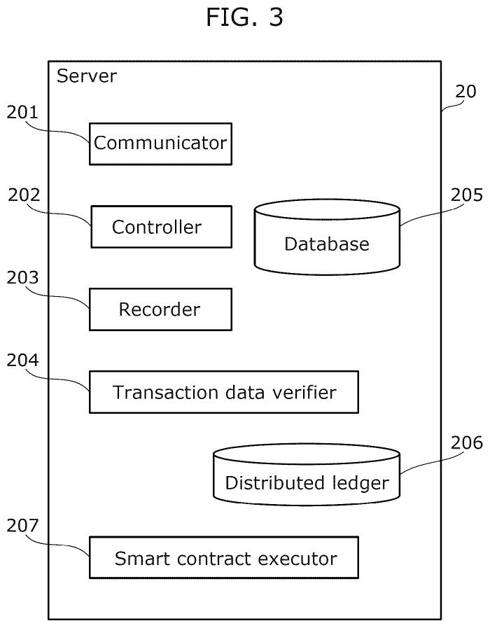

FIG. 3 is a diagram illustrating one example of the configuration of the server according to the exemplary embodiment.

Server 20 includes communicator 201, controller 202, recorder 203, transaction data verification unit 204, database 205, distributed ledger 206, and smart contract executor 207, as illustrated in FIG. 3.

Communicator 201 transmits information to information terminal 10 via the network and receives information from information terminal 10 via the network, for example. The information that is transmitted to information terminal 10 is, for example, information (notification) indicating that a penalty token has been imposed on the user of said information terminal 10. The information that is received from information terminal 10 is, for example, transaction data (for example, the first transaction data or the second transaction data) generated by information terminal 10.

Furthermore, communicator 201 communicates with another server 20 via the network. Communicator 201 transmits and receives the transaction data to and from another server 20.

In this manner, communicator 201 communicates with information terminal 10 via the network. Note that this communication may be performed using transport layer security (TLS) and a cryptographic key for TLS communication may be held in communicator 201.

Controller 202 executes a consensus algorithm for the transaction data received by communicator 201. Thus, controller 202 stores said transaction data into distributed ledger 206. For example, controller 202 connects a block including the transaction data to the blockchain of distributed ledger 206 and thus stores, into the blockchain, the information (records of consumption processes) included in said transaction data.

Furthermore, when the expiration limit is reached, controller 202 refers to the records of consumption processes stored in distributed ledger 206, and determines whether there is any resource left unconsumed by a plurality of users out of the predetermined amount of the resource. When determining that there is some resource left, that is, when there is a loss of the resource, controller 202 refers to distributed ledger 206 and calculates a retention period indicating a period for which the resource had been held between the start of the transaction and the expiration limit. The retention period is a period for which a user has held the resource without consuming or handing over the resource. In other words, the retention period is, for example, a period from when the user of information terminal 10 receives the resource to when the user consumes or handovers the resource.

Note that when the first user divides a resource into small portions and consumes or hands over the small portions, controller 202 calculates a retention period for each of the small portions of the resource (hereinafter referred to as a sub-retention period).

FIG. 4 is a diagram illustrating the amount and period of a resource consumed or handed over by each user.

In FIG. 4, time t0 indicates the time when a predetermined amount of resource 401 is generated (or obtained). Time tL indicates an expiration limit, indicating the time when the shelf life of the predetermined amount of resource 401 has elapsed since time t0. Each of time t1 to time t6 indicates the time when the resource is consumed or handed over. The circle indicates the amount of the resource consumed or handed over.

For example, the figure shows that at time t0, the first user obtains a predetermined amount (indicated herein as 100%) of resource 401. Next, at time t1, the first user hands over to the second user 25% of the predetermined amount of the resource as resource 411. Similarly, at time t2 which follows time t1, the first user hands over to the second user 50% of the predetermined amount of the resource as resource 412, and at time t3 which follows time t2, the first user hands over to the second user 25% of the predetermined amount of the resource as resource 413.

In this case, controller 202 calculates a retention period at the first user as follows. First, since resources 411, 412, 413 are small portions of the resource, controller 202 calculates a sub-retention period of each of resources 411, 412, 413. The sub-retention period of each of the resources is a period for which the first user holds the resource. Therefore, the sub-retention period of resource 411 is calculated as t1−t0, the sub-retention period of resource 412 is calculated as t2−t0, and the sub-retention period of resource 413 is calculated as t3−t0.

When the retention period is calculated, controller 202 calculates a retention period ratio of the first user. The retention period ratio is calculated by summing up sub-ratios calculated for the respective small portions of the resource. The sub-ratio is a ratio obtained by multiplying the first ratio of each of the small portions of the resource with respect to the predetermined amount of resource 401 and the ratio of the period (sub-retention period) for which the first user has held the small portion of the resource with respect to the shelf life (tL−t0). The ratio is calculated by dividing the sub-retention period by the shelf life because the shelf life may vary depending on the type of the resource and because out of the shelf life of the resource, how long the first user had held the resource without consuming or handing over the resource is to be calculated regardless of the type of the resource. The shelf life is the period from when a resource is generated to when an expiration limit is reached. In other words, the shelf life is a period in which a resource can achieve intended functions.

For example, the retention period ratio of the first user can be calculated by 25%*(t1−t0)/(tL−t0)+50%*(t2−t0)/(tL−t0)+25%*(t3−t0)/(tL−t0). Here, 25% in the first term represents the ratio of resource 411 with respect to resource 401 at time t1, 50% in the second term represents the ratio of resource 412 with respect to resource 401 at time t2, and 25% in the third term represents the ratio of resource 413 with respect to resource 401 at time t3. And (t1−t0) in the first terminal represents the period (the sub-retention period) in which the first user holds resource 411, (t2−t0) in the second terminal represents the period (the sub-retention period) in which the first user holds resource 412, and (t3−t0) in the third terminal represents the period (the sub-retention period) in which the first user holds resource 413.

Furthermore, when the expiration limit is reached, controller 202 calculates the loss of the resource by referring to distributed ledger 206. The loss of the resource is the amount of the resource left unconsumed by the plurality of users out of the predetermined amount of the resource, as described above. For example, by referring to distributed ledger 206, controller 202 may calculate the loss of the resource by subtracting the total amount of consumption of the resource from the predetermined amount of the resource. At this time, when the loss of the resource is greater than zero, controller 202 may determine that there is some resource left, and when the loss of the resource is zero, controller 202 may determine that no resource is left. For example, in the case illustrated in FIG. 4, controller 202 calculates the loss of the resource to be 5%*2, that is, 10%.

For each of the plurality of users who has obtained at least a part of the predetermined amount of the resource, controller 202 may determine a weight for the user according to the ordinal number thereof in the sequence of the handover of the predetermined amount of the resource. For example, the ordinal number of the first user is 1 because the first user holds the predetermined amount of the resource first. The ordinal number of the second user is 2 because the second user holds the resource in the second place. The ordinal number of the third user is 3 because the third user holds the resource in the third place. Note that when the ordinal number of the first user is 1 and the first user distributes and hands over the resource to the fourth user and the fifth user, this means that the fourth user and the fifth user hold the resource in the second place, and therefore the ordinal number of each of the fourth user and the fifth user is 2.

Controller 202 may determine a greater weight for a user as the ordinal number of the user increases, for example. Alternatively, controller 202 may determine a greater weight for a user as the ordinal number of the user decreases, for example.

Note that the weight may be determined to be greater as the ordinal number increases until a predetermined ordinal number and be constant after the predetermined ordinal number. Alternatively, the weight may be determined to be greater as the ordinal number decreases until a predetermined ordinal number and be constant after the predetermined ordinal number. Alternatively, the weight may be determined to be greatest with the ordinal number at the middle and be smaller as the ordinal number increases or decreases. Conversely, the weight may be determined to be smallest with the ordinal number at the middle and be greater as the ordinal number increases or decreases.

Furthermore, on the basis of the loss of the resource and the retention period ratio and the weight calculated for each user, controller 202 calculates a retention value in a retention index which is an index indicating involvement in retention of a resource. For example, for each of the plurality of users, controller 202 multiplies the loss of the resource, the retention period ratio calculated for the user, and the weight calculated for the user, to calculate the retention value of the user. This means that the retention value is calculated for each of the plurality of users. A greater retention value indicates a higher level of involvement of the user in the retention of the resource, for example. Note that a smaller retention value may indicate a higher level of involvement of the user in the retention of the resource, for example.

Controller 202 may output the retention value calculated. Specifically, controller 202 may send a notification to a user for which the retention value has been calculated and thus output the retention value calculated. This allows the user to know the level of involvement in the retention of the resource, making it possible to prompt the user to at least consume or handover the resource in a short time so that the level of involvement in the retention of the resource is lowered.

Furthermore, controller 202 may determine, as a penalty token to be imposed on a user, a greater token for a higher level of involvement in the retention of the resource that is indicated by the retention value calculated for the user. Controller 202 may collect the penalty token from the user.

Controller 202 may generate an image about a part or the whole of the diagram illustrated in FIG. 4 and output the image to display 103 of information terminal 10.

Discussion will now return to the description of FIG. 3.

When communicator 201 receives transaction data, transaction data verification unit 204 verifies the validity of the transaction data. For example, transaction data verification unit 204 verifies, for example, whether a digital signature generated in a proper method has been provided to the transaction data received by communicator 201. When the validity is verified, communicator 201 transmits copies of the transaction data to the plurality of other servers 20 and thus causes the recorders of the plurality of other servers 20 to record the authenticated transaction data that has been verified. Thus, only the transaction data, the validity of which has been verified, is transmitted to other servers; therefore, the increase in power consumption of the computer can be reduced. Note that this verification may be skipped.

Furthermore, together with the plurality of other servers 20, transaction data verification unit 204 executes a consensus algorithm for reaching an agreement about the validity of the transaction data.

As the consensus algorithm, practical byzantine fault tolerance (PBFT) may be used, or other known consensus algorithms may be used. Examples of the known consensus algorithms include proof of work (PoW) and proof of stake (PoS). When the PBFT is used as the consensus algorithm, transaction data verification unit 204 receives, from each of the plurality of servers 20, a report indicating whether the verification of the transaction data has been successful, and determines whether the number of such reports exceeds a predetermined number. It is sufficient that when the number of reports exceeds the predetermined number, transaction data verification unit 204 determine that the validity of the transaction data has been verified using the consensus algorithm.

When confirming the validity of the transaction data, transaction data verification unit 204 causes recorder 203 to record the transaction data. When the validity of the transaction data is not verified, transaction data verification unit 204 discards the transaction data. As a result, the transaction data, the validity of which is not verified, is not recorded into the recorder; therefore, the required amount of computer resources can be reduced. Transaction data verification unit 204 may generate a block including the transaction data, the validity of which has been confirmed, and store the generated block into distributed ledger 206.

In the present exemplary embodiment, transaction data verification unit 204 verifies the validity of the transaction data received by communicator 201.

Note that recorder 203 stores, into distributed ledger 206, the transaction data, the validity of which has been verified by transaction data verification unit 204, thereby recording the transaction data. Thus, the transaction data can be protected from tampering.

Note that recorder 203 may be formed inside distributed ledger 206.

In database 205, a plurality of items of log information are stored. Database 205 is embodied using storage.

In distributed ledger 206, transaction data is stored. Since distributed ledger 206 sequentially obtains and stores transaction data, transaction data for one or more transactions is stored in distributed ledger 206. Distributed ledger 206 is embodied using storage.

Smart contract executor 207 operates the smart contract by executing a contract code, etc., included in the transaction data stored in the blockchain of distributed ledger 206. Smart contract executor 207 operates a first smart contract when the first transaction data is stored into the blockchain of distributed ledger 206. Thus, smart contract executor 207 causes controller 202 to perform the process of adding 1 to the latest ordinal number, which is specified by referring to distributed ledger 206, in the sequence of the handover of the predetermined amount of the resource. This means that the first smart contract is a smart contract for performing the process of adding 1 to the latest ordinal number, which is specified by referring to distributed ledger 206, in the sequence of the handover of the predetermined amount of the resource. Furthermore, by operating the first smart contract, smart contract executor 207 may cause controller 202 to perform the process of determining whether the timestamp included in the first transaction data is beyond the expiration limit. This means that the first smart contract may be a smart contract for further performing the process of determining whether the timestamp included in the first transaction data is beyond the expiration limit.

Furthermore, smart contract executor 207 operates a second smart contract when the second transaction data is stored into the blockchain of distributed ledger 206. Thus, smart contract executor 207 causes controller 202 to calculate the retention period, the loss, the weight, and the retention value. This means that the second smart contract is a smart contract for calculating the retention period, the loss, the weight, and the retention value.

In this manner, by operating the smart contract, smart contract executor 207 can manage various processes using the distributed ledger. Note that an application on information terminal 10 generates the first smart contract and the second smart contract on the basis of an operation performed by a user, for example, and blocks including these smart contracts have been stored in the blockchain in advance. This means that the contract code of the first smart contract and the contract code of the second smart contract are stored in the blockchain.

Note that the contract code of the first smart contract and the contract code of the second smart contract may be separately stored in the blockchain or may be stored in the blockchain as one integrated contract code.

### [Operation]

Next, the operation of management system 1 configured as described above will be described.

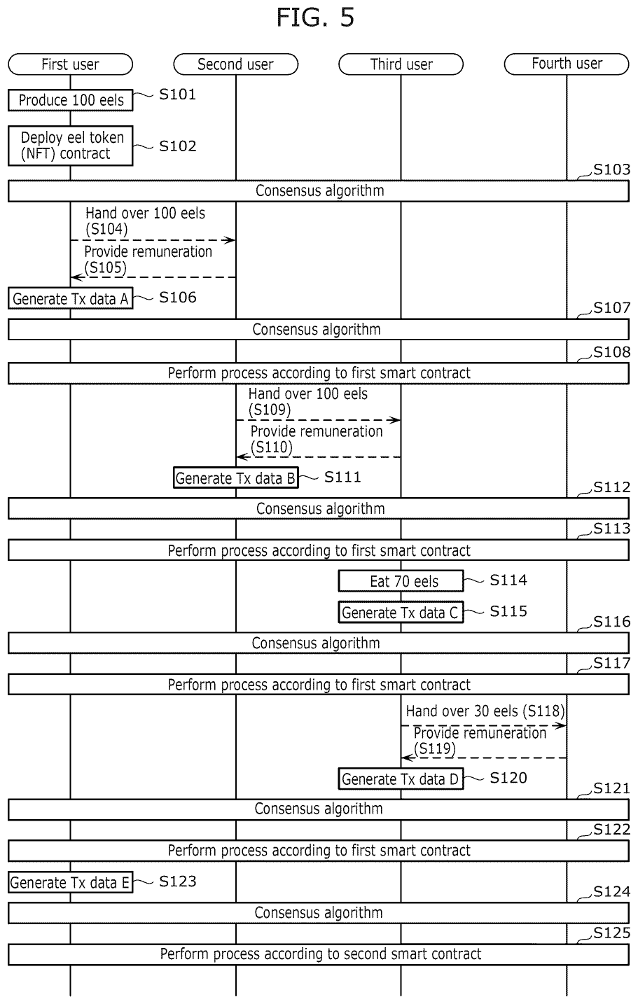

FIG. 5 is a sequence chart illustrating one example of the operation of the management system according to the exemplary embodiment.

In FIG. 5, eels (food products that contain eels as an ingredient) are indicated as an example of the resource. Complete eel farming is challenging and it is difficult to increase the population of eels; therefore, there is a demand that producers of food products that contain eels as an ingredient adjust the quantity thereof during production. The first user is a producer of food products that contain eels as an ingredient and because the first user is included in targets to be managed by management system 1, it is possible to impose a penalty on the eel producer as well for the food loss caused due to mass production. FIG. 5 includes not only the operation of management system 1, but also the operations performed by the plurality of users. The operations performed by the plurality of users are indicated by dashed lines. In FIG. 5, the first user indicates the process performed by information terminal 10a or server 20a, the second user indicates the process performed by information terminal 10b or server 20b, the third user indicates the process performed by information terminal 10c or server 20c, and the fourth user indicates the process performed by information terminal 10d or server 20d.

First, the first user produces 100 eel products (S101).

Information terminal 10a of the first user receives an operation from the first user and generates and deploys transaction data including an eel token contract (S102). The eel token contract is, for example, a non-fungible token (NFT). The eel token contract includes: the number of eel products; a distribution order (ordinal number); a consumption state indicating whether the eel products have been consumed; and the expiration limit (shelf life) of the eel products. The eel token contract may further include the source and destination of movement of the eel products, a function for calculating a penalty token, and a function for changing the consumption state.

Thus, server 20a receives the transaction data from information terminal 10a and transfers the transaction data to other servers 20b to 20d, and servers 20a to 20d execute the consensus algorithm and store the transaction data into distributed ledger 206 (S103).

Next, the first user hands the 100 eel products over to the second user (S104).

Next, the second user provides remuneration for the 100 eel products to the first user (S105).

Information terminal 10a receives an operation from the first user and generates Tx data A (S106). Note that the term “Tx data” indicates transaction data. Tx data A includes: information indicating that the 100 eel products have been handed over from the first user to the second user; and the time when the handover takes place. In other words, Tx data A includes the number (amount) of eel products, a source user, a destination user, and the date and time of the handover. Note that information terminal 10b may perform the process in Step S106.

Information terminal 10a transmits Tx data A to server 20a, server 20a receives Tx data A and transfers Tx data A to other servers 20b to 20d, and servers 20a to 20d execute the consensus algorithm and store Tx data A into distributed ledger 206 (S107). Tx data A is one example of the first transaction data.

Next, servers 20a to 20d perform the process according to the first smart contract (S108). Thus, servers 20a to 20d perform the process of adding 1 to the latest ordinal number, which is specified by referring to distributed ledger 206, in the sequence of the handover of the predetermined amount of the resource. Thus, the ordinal number of the user for the resource that has been handed over is calculated to be 2 as a result of the addition of 1 to the initial value (for example, 1). Furthermore, servers 20a to 20d perform the process of determining whether the timestamp included in the first transaction data is beyond the expiration limit. When the timestamp is not beyond the expiration limit, the next process is continuously performed.

Next, the second user hands the 100 eel products over to the third user (S109).

Next, the third user provides remuneration for the 100 eel products to the second user (S110).

Information terminal 10b receives an operation from the second user and generates Tx data B (S111). Tx data B includes: information indicating that the 100 eel products have been handed over from the second user to the third user; and the time when the handover takes place. In other words, Tx data B includes the number (amount) of eel products, a source user, a destination user, and the date and time of the handover. Note that information terminal 10c may perform the process in Step S111.

Information terminal 10b transmits Tx data B to server 20b, server 20b receives Tx data B and transfers Tx data B to other servers 20a, 20c, 20d, and servers 20a to 20d execute the consensus algorithm and store Tx data B into distributed ledger 206 (S112). Tx data B is one example of the first transaction data.

Next, servers 20a to 20d perform the process according to the first smart contract (S113). Thus, servers 20a to 20d perform the process of adding 1 to the latest ordinal number, which is specified by referring to distributed ledger 206, in the sequence of the handover of the predetermined amount of the resource. Thus, the ordinal number of the user for the resource that has been handed over is calculated to be 3 as a result of the addition of 1 to the last ordinal number calculated, i.e., 2. Furthermore, servers 20a to 20d perform the process of determining whether the timestamp included in the first transaction data is beyond the expiration limit. When the timestamp is not beyond the expiration limit, the next process is continuously performed.

Next, the third user eats and thus consumes 70 eel products (S114).

Information terminal 10c receives an operation from the third user and generates Tx data C (S115). Tx data C includes: information indicating that the third user has consumed 70 eel products; and the time when the consumption takes place. In other words, Tx data C includes the number (amount) of eel products, a user who has consumed the eel products, and the date and time of the consumption. Note that the data format of Tx data C may be substantially the same as that used for the handover; Tx data C may include the items of a source user and a destination user. When the source user and the destination user are the same, this may indicate that the resource has been consumed, and when the source user and the destination user are different, this may indicate that the resource has been handed over. Note that information terminal 10c may perform the process in Step S115.

Information terminal 10c transmits Tx data C to server 20c, server 20c receives Tx data C and transfers Tx data C to other servers 20a, 20b, 20d, and servers 20a to 20d execute the consensus algorithm and store Tx data C into distributed ledger 206 (S116). Tx data C is one example of the first transaction data.

Next, servers 20a to 20d perform the process according to the first smart contract (S117). At this time, since the consumption has taken place instead of the handover, servers 20a to 20d do not change the ordinal number in the sequence of the handover of the predetermined amount of resource. Furthermore, servers 20a to 20d perform the process of determining whether the timestamp included in the first transaction data is beyond the expiration limit. When the timestamp is not beyond the expiration limit, the next process is continuously performed.

Next, the third user hands the 30 eel products over to the fourth user (S118).

Next, the fourth user provides remuneration for the 30 eel products to the third user (S119).

Information terminal 10c receives an operation from the third user and generates Tx data D (S120). Tx data D includes: information indicating that the 30 eel products have been handed over from the third user to the fourth user; and the time when the handover takes place. In other words, Tx data D includes the number (amount) of eel products, a source user, a destination user, and the date and time of the handover. Note that information terminal 10d may perform the process in Step S120.

Information terminal 10c transmits Tx data D to server 20c, server 20c receives Tx data D and transfers Tx data D to other servers 20a, 20b, 20d, and servers 20a to 20d execute the consensus algorithm and store Tx data D into distributed ledger 206 (S121). Tx data D is one example of the first transaction data.

Next, servers 20a to 20d perform the process according to the first smart contract (S122). Thus, servers 20a to 20d perform the process of adding 1 to the latest ordinal number, which is specified by referring to distributed ledger 206, in the sequence of the handover of the predetermined amount of the resource. Thus, the ordinal number of the user for the resource that has been handed over is calculated to be 4 as a result of the addition of 1 to the last ordinal number calculated, i.e., 3. Furthermore, servers 20a to 20d perform the process of determining whether the timestamp included in the first transaction data is beyond the expiration limit. When the timestamp is not beyond the expiration limit, the next process is continuously performed.

When the expiration limit is reached, information terminal 10a generates Tx data E (S123). Tx data E includes: the ID of the resource, the expiration limit of which has been reached; and information indicating that the expiration limit has been reached. Note that the process in Step S123 may be performed by one of information terminals 10b to 10d or may be performed by one of servers 20a to 20d.

Information terminal 10a transmits Tx data E to server 20a, server 20a receives Tx data E and transfers Tx data E to other servers 20b to 20d, and servers 20a to 20d execute the consensus algorithm and store Tx data E into distributed ledger 206 (S124). Tx data E is one example of the second transaction data.

Next, servers 20a to 20d perform the process according to the second smart contract (S125). Thus, servers 20a to 20d calculate the retention period, the loss, the weight, and the retention value. In this manner, the retention value for each user is calculated.

### Advantageous Effects, Etc.

One device included in the management system according to the present exemplary embodiment performs the following as a management method. In a management system including a plurality of devices each holding a distributed ledger for managing a record of a consumption process in which a plurality of users including a first user and a second user consume a resource with an expiration limit, the management method is performed by one device included in the plurality of devices. When the first user performs at least one of (i) consuming a first amount of a resource out of a predetermined amount of a resource with an expiration limit or (ii) handing a second amount of a resource out of the predetermined amount of the resource over to the second user, the one device (server 20) stores, into the distributed ledger, first transaction data including a record of at least one of the consumption and the handover by the first user (S107). When there is a loss of the resource that is left unconsumed by the plurality of users upon the expiration limit out of the predetermined amount of the resource, server 20 calculates, by referring to the distributed ledger, a retention period indicating a period for which the first user has held the resource. Server 20 calculates, based on the retention period, a retention value of the first user that is included in a retention index which is an index indicating involvement in retention of the resource, and outputs the retention value calculated.

With this, a retention value in a retention index which is an index indicating involvement of the first user in retention of a resource, in other words, a retention value serving as an evaluation value for retention of a resource by the first user, is calculated, and the retention value is output. A large retention value is likely to lead to significant loss; therefore, the retention value of the first user can be regarded as a level of involvement of the first user, among the plurality of users who have involved in the handover of the resource, in the loss that has occurred. This means that the level of involvement of the first user in the loss can be calculated by calculating the retention value of the first user. Accordingly, for example, by applying measures to the first user such as imposing on the first user a penalty that corresponds to the retention value, it is possible to prompt the first user to quickly consume or hand over the resource so that the retention value is reduced. Thus, there is a possibility that the loss can be reduced.

Furthermore, the one device according to the present exemplary embodiment further calculates the loss of the resource by referring to the distributed ledger when the expiration limit is reached. The retention value is calculated based on the loss of the resource, the retention amount, and the retention period.

With this, it is possible to determine a retention value corresponding to the loss that has occurred. Therefore, for example, when two or more different losses occur, it is possible to determine respective retention values corresponding to said losses.

Furthermore, the one device according to the present exemplary embodiment further determines, according to an ordinal number in a sequence of the plurality of users to whom the predetermined amount of the resource has been handed over, a weight for each of the plurality of users who has obtained at least a part of the predetermined amount of the resource. The retention value is calculated based on the weight determined for the first user, the loss, and the retention period. Therefore, it is possible to determine a retention value according to an ordinal number in the sequence of the handover.

Furthermore, in the one device according to the present exemplary embodiment, the weight may be determined to be greater as the ordinal number increases. Therefore, it is possible to make later participation in the process of consuming the resource more difficult, meaning that a user who is not capable of consuming the resource until the expiration limit can be kept from receiving the resource.

Furthermore, in the one device according to the present exemplary embodiment, the weight may be determined to be greater as the ordinal number decreases. Therefore, it is possible to facilitate later participation of many users in the process of consuming the resource, meaning that a larger amount of the resource may be consumed by users who have participated later; thus, there is a possibility that the occurrence of loss can be reduced.

Furthermore, the one device according to the present exemplary embodiment further determines a greater token for a higher level of the involvement in the retention of the resource that is indicated by the retention value. The one device collects the token from the first user.

Accordingly, a penalty that corresponds to the retention value can be imposed on the first user, meaning that it is possible to prompt the first user to quickly consume or hand over the resource so that the retention value is reduced. Thus, there is a possibility that the loss can be reduced.

Furthermore, in the one device according to the present exemplary embodiment, a first smart contract for performing the process of adding 1 to the latest ordinal number, which is specified by referring to distributed ledger 206, in the sequence of the handover of the predetermined amount of the resource is stored in distributed ledger 206. The first smart contract is executed when the first transaction data is stored. Therefore, the ordinal number can be automatically determined.

Furthermore, in the one device according to the present exemplary embodiment, the first smart contract is a smart contract for further performing the process of determining whether a timestamp included in the first transaction data is beyond the expiration limit. Therefore, whether the expiration limit has passed can be determined every time the first transaction data is stored into distributed ledger 206.

Furthermore, in the one device according to the present exemplary embodiment, a second smart contract for calculating the retention period and the retention value is further stored in distributed ledger 206. The second smart contract is executed when second transaction data including expiry information indicating that the expiration limit has been reached is stored into the distributed ledger. Therefore, when the expiration limit is reached, the second smart contract allows for automatic calculation of the retention amount, the retention period, and the retention value.

Furthermore, in the one device according to the present exemplary embodiment, the retention value is calculated for each of the plurality of users. Therefore, the plurality of users can be evaluated, and a user having a small retention value can be evaluated as a reliable user. When the reliability of users improves, it is possible to provide an environment (system) that is user-friendly for reliable users.

### [Variation 1]

In the above exemplary embodiment, information terminal 10 receives an operation from a user and thus generates the transaction data, but this is not limiting; in another possible embodiment, device 30 generates the transaction data without operational intervention from users.

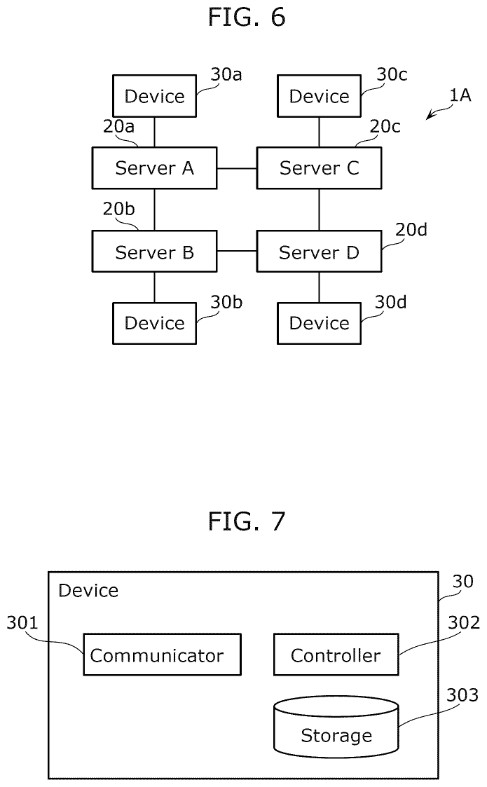

FIG. 6 is a diagram illustrating one example of the configuration of a management system according to Variation 1.

Management system 1A according to the present disclosure includes, for example, a plurality of devices 30a to 30d and a plurality of servers 20a to 20d, as illustrated in FIG. 6. These are connected via a network not illustrated in the drawings. The network, which is the Internet or a cell-phone carrier network, for example, may include any communication line or network. Devices 30a to 30e are artificial intelligence (AI) home appliances, for example. Furthermore, management system 1A may include information terminal 10.

Server 20a exchanges information with device 30a, server 20b exchanges information with device 30b, server 20c exchanges information with device 30c, and server 20d exchanges information with device 30d. Note that each of devices 30a to 30d may exchange information with a server different from the corresponding server.

Note that in the following description, each of device 30a to 30d will also be referred to as device 30, and device 30a to 30d may also be referred to as devices A to D. Similarly, each of servers 20a to 20d will also be referred to as server 20, and servers 20a to 20d may also be referred to as servers A to D.

Management system 1A manages records of the process of consuming the amount of electricity scheduled to be consumed by device 30 from sunset to sunrise, for example. The amount of electricity scheduled to be consumed by device 30 is, for example, a total amount of electricity generated by a photovoltaic system and stored in a storage battery until sunset. The resource in this case is the total amount of electricity stored in the storage battery.

### [Device 30]

Device 30 calculates, on the basis of records of use of electricity up to this point, an amount of electricity estimated to be used from sunset to sunrise (hereinafter referred to as a scheduled electricity usage amount). Device 30 requests that the calculated scheduled electricity usage amount of electricity be used after sunset. For example, device 30 transmits a request for use of the calculated scheduled electricity usage amount of electricity after sunset to servers 20a to 20d. Device 30 uses electricity on the basis of an allowed electricity usage amount determined by servers 20a to 20d. The allowed electricity usage amount is the amount of electricity that device 30 is allowed to use between sunset and sunrise. When an operation providing a basis for calculation of the scheduled electricity usage amount has not been performed even at the scheduled time, device 30 may hand over to another device 30 the allowed electricity usage amount of the electricity estimated to be consumed by said operation.

FIG. 7 is a diagram illustrating one example of the configuration of the device according to Variation 1.

Device 30 includes communicator 301, controller 302, and storage 303.

Communicator 301 transmits information to server 20 via the network and receives information from server 20 via the network, for example. The information that is transmitted to server 20 is, for example, information indicating the scheduled electricity usage amount calculated by device 30 or the transaction data generated by device 30. The information that is received from server 20 is, for example, information indicating the allowed electricity usage amount or information (notification) indicating that a penalty has been imposed on said device 30. Every time transaction data is generated, communicator 301 transmits the generated transaction data to server 20.

In this manner, communicator 301 communicates with servers 20a to 20d via the network. Note that this communication may be performed using transport layer security (TLS) and a cryptographic key for TLS communication may be held in communicator 301.

Controller 302 controls the operation of device 30 from sunset to sunrise on the basis of the allowed electricity usage amount received from server 20. Furthermore, on the basis of operation records stored in storage 303, controller 302 calculates an amount of electricity estimated to be used from sunset to sunrise. Controller 302 may calculate, for each type of operation, an amount of electricity estimated to be used from sunset to sunrise. For example, controller 302 may calculate the scheduled electricity usage amount by calculating an average value of the operation records between sunset and sunrise in a predetermined period. Controller 302 transmits the request for use of the calculated scheduled electricity usage amount of electricity to server 20 via communicator 301.

Storage 303 stores the operation records of device 30. Storage 303 stores, for example, the type of the operation performed by device 30, the electricity consumed by said operation, and the time when said operation is performed.

Note that the plurality of devices 30 are one example of the plurality of users who use the resource (the amount of electricity).

The configuration of server 20 is basically the same as that in the exemplary embodiment and therefore, detailed description thereof will be omitted. A difference in the processing of server 20 is that on the basis of the request from device 30 and the predetermined priority of the operations of the plurality of devices 30, controller 202 determines the allowed electricity usage amount to be allocated to each device 30. For example, the priority of an operation necessary for daily life may be determined to be higher than (in other words, to be prioritized over) operations for hobbies and preferences. For example, the priority of the operation of a major home appliance may be determined to be higher than the priority of the operation of an audio/visual home appliance.

FIG. 8 is a diagram illustrating the amount and period of a resource consumed or handed over by each device.

In FIG. 8, time t0 indicates the time when the predetermined amount of resource (allowed electricity usage amount) 501 is generated, specifically, the time when power generation by the photovoltaic system ends and charging of the storage battery with the electricity generated by the photovoltaic system ends. Time tL, which indicates the expiration limit, indicates the scheduled time when the power generation by the photovoltaic system will resume and the charging of the storage battery with the electricity generated by the photovoltaic system will resume. Time t0 corresponds to sunset time, for example, but does not necessarily need to match sunset time. Time tL corresponds to sunrise time, for example, but does not necessarily need to match sunrise time. Each of time t1 to time t3 indicates the time when the resource is consumed or handed over. The circle indicates the amount of the resource consumed or handed over.

For example, the diagram shows that the storage battery obtains the predetermined amount (in this example, indicated as 100%) of resource 501 at time t0. Next, the storage battery handed 90% of the predetermined amount of the resource, namely, resource 511, over to device 30a at time t0. Device 30a is, for example, an air conditioner. Similarly, at time t0, the storage battery handed 8% of the predetermined amount of the resource, namely, resource 512, over to device 30b and handed 4% of the predetermined amount of the resource, namely, resource 512, over to device 30c. Device 30b is a microwave oven, for example, and device 30c is a television set, for example.

However, at time t1, device 30b consumes less electricity than scheduled and therefore, part of the allowed electricity usage amount allocated to device 30b is handed over to device 30c at time t2.

Furthermore, at time t3, device 30a and device 30c consume less electricity than scheduled and therefore, part of the allowed electricity usage amounts allocated to device 30a and device 30c is handed over to device 30d and device 30e.

Even in this case, controller 202 can calculate the retention value for each device as in the exemplary embodiment.

When a penalty is imposed, this means that the calculated scheduled electricity usage amount has a wide margin of error and therefore, device 30 may change the method for calculating the scheduled electricity usage amount. Specifically, when a penalty is imposed, device 30 may calculate a smaller scheduled electricity usage amount.

Furthermore, when a penalty is imposed, device 30 may transmit, to other devices such as server 20, a request for updating an algorithm for calculating the scheduled electricity usage amount of device 30 to make the algorithm accurate. Thus, a device having an inaccurate algorithm can be updated with high priority.

Alternatively, the update request may be a repair request. Thus, an improperly operating device can be updated with high priority.

With management system 1A according to Variation 1, device 30 can operate so as to use up electricity stored in the storage battery and therefore, the amount of electricity stored in the storage battery at the time of power generation by the photovoltaic system can be close to zero. Therefore, it is possible to reduce the occurrence of the electricity generated by the photovoltaic system being discarded without being stored because the storage battery is fully charged.

Controller 202 may generate an image about a part or the whole of the diagram illustrated in FIG. 8 and output the image to display 103 of information terminal 10.

### [Variation 2]

While the above exemplary embodiment describes the operation performed in an example in which the resource is objects such as eel food, the following will describe the operation performed in an example in which the resource is a logical resource.

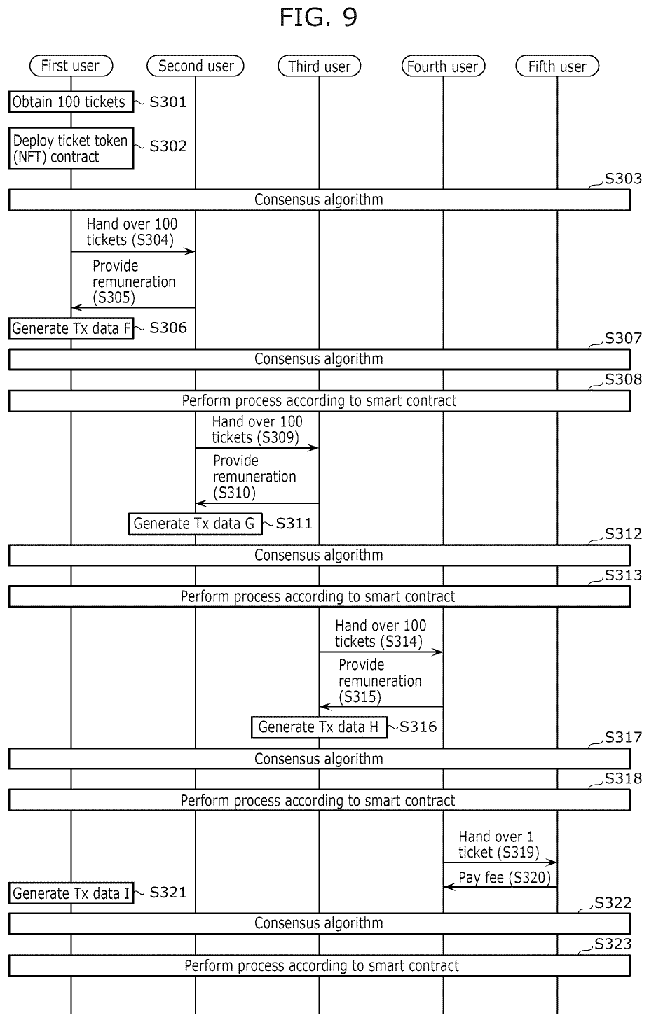

FIG. 9 is a sequence chart illustrating one example of the operation of a management system according to Variation 2.

In FIG. 9, tickets (for example, electronic tickets) are indicated as an example of the logical resource. Unlike the case shown in FIG. 5, only the operation of management system 1 is required in FIG. 9 because the operation is trading electronic tickets. This means that FIG. 9 does not include operations performed by the plurality of users. In FIG. 9, the first user indicates the process performed by information terminal 10a or server 20a, the second user indicates the process performed by information terminal 10b or server 20b, the third user indicates the process performed by information terminal 10c or server 20c, and the fourth user indicates the process performed by information terminal 10d or server 20d.

First, the first user obtains 100 tickets (S301).

Information terminal 10a of the first user receives an operation from the first user and generates and deploys transaction data including a ticket token contract (S302). The ticket token contract is, for example, a non-fungible token (NFT). The ticket token contract includes: the number of tickets; a distribution order (ordinal number); a consumption state indicating whether the tickets have been consumed; the expiration limit (shelf life) of the tickets; and records of use of the tickets. The expiration limit of the tickets is opening of an event for which the tickets have been issued or the departure time of a vehicle for which the tickets have been issued, for example. The records of use of the tickets is information indicating whether the tickets have been used and consumed. The ticket token contract may further include the source and destination of movement of the tickets, a function for calculating a penalty token, and a function for changing the consumption state.

Thus, server 20a receives the transaction data from information terminal 10a and transfers the transaction data to other servers 20b to 20d, and servers 20a to 20d execute the consensus algorithm and store the transaction data into distributed ledger 206 (S303).

Next, the first user hands 100 tickets to the second user (S304).

Next, the second user provides remuneration for the 100 tickets to the first user (S305).

Information terminal 10a receives an operation from the first user and generates Tx data F (S306). Tx data F includes: information indicating that the 100 tickets have been handed over from the first user to the second user; and the time when the handover takes place. In other words, Tx data F includes the number (amount) of tickets, a source user, a destination user, and the date and time of the handover. Note that information terminal 10b may perform the process in Step S306.

Information terminal 10a transmits Tx data F to server 20a, server 20a receives Tx data F and transfers Tx data F to other servers 20b to 20d, and servers 20a to 20d execute the consensus algorithm and store Tx data F into distributed ledger 206 (S307). Tx data F is one example of the first transaction data.

Next, servers 20a to 20d perform the process according to the first smart contract (S308). Thus, servers 20a to 20d perform the process of adding 1 to the latest ordinal number, which is specified by referring to distributed ledger 206, in the sequence of the handover of the predetermined amount of the resource. Thus, the ordinal number of the user for the resource that has been handed over is calculated to be 2 as a result of the addition of 1 to the initial value (for example, 1). Furthermore, servers 20a to 20d perform the process of determining whether the timestamp included in the first transaction data is beyond the expiration limit. When the timestamp is not beyond the expiration limit, the next process is continuously performed.

Next, the second user hands 100 tickets over to the third user (S309).

Next, the third user provides remuneration for the 100 tickets to the second user (S310).

Information terminal 10b receives an operation from the second user and generates Tx data G (S311). Tx data G includes: information indicating that the 100 tickets have been handed over from the second user to the third user; and the time when the handover takes place. In other words, Tx data G includes the number (amount) of tickets, a source user, a destination user, and the date and time of the handover. Note that information terminal 10c may perform the process in Step S311.

Information terminal 10b transmits Tx data G to server 20b, server 20b receives Tx data G and transfers Tx data G to other servers 20a, 20c, 20d, and servers 20a to 20d execute the consensus algorithm and store Tx data G into distributed ledger 206 (S312). Tx data G is one example of the first transaction data.

Next, servers 20a to 20d perform the process according to the first smart contract (S313). Thus, servers 20a to 20d perform the process of adding 1 to the latest ordinal number, which is specified by referring to distributed ledger 206, in the sequence of the handover of the predetermined amount of the resource. Thus, the ordinal number of the user for the resource that has been handed over is calculated to be 3 as a result of the addition of 1 to the last ordinal number calculated, i.e., 2. Furthermore, servers 20a to 20d perform the process of determining whether the timestamp included in the first transaction data is beyond the expiration limit. When the timestamp is not beyond the expiration limit, the next process is continuously performed.

Next, the third user hands 100 tickets to the fourth user (S314).

Next, the fourth user provides remuneration for the 100 tickets to the second user (S315).

Information terminal 10c receives an operation from the third user and generates Tx data H (S316). Tx data H includes: information indicating that the 100 tickets have been handed over from the third user to the fourth user; and the time when the handover takes place. In other words, Tx data H includes the number (amount) of tickets, a source user, a destination user, and the date and time of the handover. Note that information terminal 10d may perform the process in Step S316.

Information terminal 10c transmits Tx data H to server 20c, server 20c receives Tx data H and transfers Tx data H to other servers 20a, 20b, 20d, and servers 20a to 20d execute the consensus algorithm and store Tx data H into distributed ledger 206 (S317). Tx data H is one example of the first transaction data.

Next, servers 20a to 20d perform the process according to the first smart contract (S318). Thus, servers 20a to 20d perform the process of adding 1 to the latest ordinal number, which is specified by referring to distributed ledger 206, in the sequence of the handover of the predetermined amount of the resource. Thus, the ordinal number of the user for the resource that has been handed over is calculated to be 4 as a result of the addition of 1 to the last ordinal number calculated, i.e., 3. Furthermore, servers 20a to 20d perform the process of determining whether the timestamp included in the first transaction data is beyond the expiration limit. When the timestamp is not beyond the expiration limit, the next process is continuously performed.

When the expiration limit is reached, information terminal 10a generates Tx data I (S321). Tx data I includes: the ID of the resource, the expiration limit of which has been reached; and information indicating that the expiration limit has been reached. Note that the process in Step S321 may be performed by one of information terminals 10b to 10d or may be performed by one of servers 20a to 20d.

Information terminal 10a transmits Tx data I to server 20a, server 20a receives Tx data I and transfers Tx data I to other servers 20b to 20d, and servers 20a to 20d execute the consensus algorithm and store Tx data I into distributed ledger 206 (S322). Tx data I is one example of the second transaction data.

Next, servers 20a to 20d perform the process according to the second smart contract (S323). Thus, servers 20a to 20d calculate the retention period, the loss, the weight, and the retention value. In this manner, the retention value for each user is calculated.

### Other Exemplary Embodiments, Etc.

The present disclosure has been described thus far based on the above exemplary embodiment, but it goes without saying that the present disclosure is not limited to the above exemplary embodiment. The following examples are also intended to be included within the scope of the present disclosure.

(1) In the above exemplary embodiment, the server holding the distributed ledger and the information terminal that receives an operation from a user are separate, but this is not limiting; the information terminal that receives an operation from a user may hold the distributed ledger and perform the process of managing the distributed ledger. This means that the above-described functions of the server and the above-described functions of the information terminal may be included in a single device. Similarly, in Variation 1, the server holding the distributed ledger and the device are separate, but this is not limiting; the device may hold the distributed ledger and perform the process of managing the distributed ledger. This means that the above-described functions of the server and the above-described functions of the device may be included in a single device.

(2) In the above exemplary embodiment, controller 202 calculates the retention value of each of the plurality of users by multiplying the loss of the resource, the retention period, and the weight, but this is not limiting; the retention value may be calculated by multiplying the retention period and the weight, may be calculated by multiplying the loss and the retention period, or may be calculated using only the retention period.

(3) Each of the devices according to the above exemplary embodiment is specifically a computer system configured from a microprocessor, read-only memory (ROM), random-access memory (RAM), a hard disk unit, a display unit, a keyboard, and a mouse, for example. A computer program is recorded in the RAM or the hard disk unit. Each of the devices achieves its function as a result of the microprocessor operating according to the computer program. Here, the computer program is configured of a combination of command codes indicating instructions to the computer in order to achieve a predetermined function.

(4) Some or all of the structural elements included in each of the devices according to the above exemplary embodiment may be configured from a single system Large Scale Integration (LSI). A system LSI is a super-multifunctional LSI manufactured with a plurality of components integrated on a single chip, and is specifically a computer system configured of a microprocessor, ROM, and RAM, for example. A computer program is recorded in the RAM. The system LSI achieves its function as a result of the microprocessor operating according to the computer program.

Furthermore, each unit of the structural elements included in each of the devices described above may be individually configured into a single chip, or some or all of the units may be configured into a single chip.

Moreover, although a system LSI is mentioned here, the integrated circuit can also be called an IC, a LSI, a super LSI, and an ultra LSI, depending on the level of integration. Furthermore, the method of circuit integration is not limited to LSIs, and implementation through a dedicated circuit or a general-purpose processor is also possible. A field programmable gate array (FPGA) which allows programming after LSI manufacturing or a reconfigurable processor which allows reconfiguration of the connections and settings of the circuit cells inside the LSI may also be used.

In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

(5) Some or all of the structural elements included in each of the devices described above may be implemented as a standalone module or an IC card that can be inserted into and removed from the device. The IC card or the module is a computer system made up of a microprocessor, ROM, RAM, and so on. The IC card or the module may include the aforementioned super-multifunctional LSI. The IC card or the module achieves its functions as a result of the microprocessor operating according to the computer program. The IC card and the module may be tamper-proof.

(6) The present disclosure may be the above-described methods. Furthermore, the present disclosure may be a computer program for implementing these methods using a computer or may be a digital signal of the computer program.

Furthermore, the present disclosure may be the computer program or the digital signal recorded on recording media readable by a computer, such as a flexible disk, a hard disk, a compact disc read-only memory (CD-ROM), a magneto-optical disc (MO), a digital versatile disc (DVD), a DVD-ROM, a DVD-RAM, a Blu-ray (registered trademark) disc (BD), or a semiconductor memory, for example. The present disclosure may also be the digital signal recorded on these recoding media.

Furthermore, in the present disclosure, the computer program or the digital signal may be transmitted via an electrical communication line, a wireless or wired communication line, a network represented by the Internet, data broadcasting, or the like.

Furthermore, the present disclosure may be a computer system including a microprocessor and memory. The memory may have the computer program recorded thereon, and the microprocessor may operate according to the computer program.

Moreover, by transferring the recording medium having the program or the digital signal recorded thereon or by transferring the program or the digital signal via the network or the like, the present disclosure may be implemented by a different independent computer system.

(7) The above exemplary embodiment and the above variations may be combined with each other.

### INDUSTRIAL APPLICABILITY

The present disclosure can be used for management methods, devices, and recording media, and can be used, for example, as a management method, a device, a recording medium, and the like by which the loss can be reduced.

1. A management method performed by one of a plurality of devices included in a management system, the plurality of devices each holding a distributed ledger for managing a record of a consumption process in which a plurality of users including a first user and a second user consume a resource with an expiration limit, the management method comprising:
storing first transaction data into the distributed ledger when the first user performs at least one of (i) consuming a first amount of a resource out of a predetermined amount of a resource with an expiration limit or (ii) handing a second amount of a resource out of the predetermined amount of the resource over to the second user, the first transaction data including a record of the at least one of the consumption and the handover by the first user;
when a loss of the resource is found, calculating a retention period by referring to the distributed ledger, the loss of the resource being a remaining amount of a resource left unconsumed by the plurality of users upon the expiration limit out of the predetermined amount of the resource, the retention period indicating a period for which the first user has held the resource; and
calculating a retention value of the first user based on the retention period, and outputting the retention value calculated, the retention value being included in a retention index which is an index indicating involvement in retention of the resource.

2. The management method according to claim 1, further comprising:
calculating the loss of the resource by referring to the distributed ledger when the expiration limit is reached, wherein
the retention value is calculated based on the loss of the resource and the retention period.

3. The management method according to claim 2, further comprising:
determining, according to an ordinal number in a sequence of the plurality of users to whom the predetermined amount of the resource has been handed over, a weight for each of the plurality of users who has obtained at least a part of the predetermined amount of the resource, wherein
the retention value is calculated based on the weight determined for the first user, the loss, and the retention period.

4. The management method according to claim 3, wherein
the weight is determined to be greater as the ordinal number increases.

5. The management method according to claim 3, wherein
the weight is determined to be greater as the ordinal number decreases.

6. The management method according to claim 1, further comprising:
determining a greater token for a higher level of the involvement in the retention of the resource that is indicated by the retention value; and
collecting the token from the first user.

7. The management method according to claim 1, wherein
a first smart contract is stored in the distributed ledger, the first smart contract being a smart contract for performing a process of adding 1 to a latest ordinal number in a sequence of the handover of the predetermined amount of the resource, the latest ordinal number being specified by referring to the distributed ledger, and
the first smart contract is executed when the first transaction data is stored.

8. The management method according to claim 7, wherein
the first smart contract is a smart contract for further performing a process of determining whether a timestamp included in the first transaction data is beyond the expiration limit.

9. The management method according to claim 1, wherein
a second smart contract for calculating the retention period and the retention value is further stored in the distributed ledger, and
the second smart contract is executed when second transaction data is stored into the distributed ledger, the second transaction data including expiry information indicating that the expiration limit has been reached.

10. The management method according to claim 1, wherein
the resource of the predetermined amount is an object that deteriorates over time and when the expiration limit is exceeded, loses a predetermined function.

11. The management method according to claim 1, wherein
the resource of the predetermined amount is a logical resource that expires when the expiration limit is exceeded.

12. The management method according to claim 1, wherein
the retention value is calculated for each of the plurality of users.

13. A device that is one of a plurality of devices included in a management system, each of the plurality of devices holding a distributed ledger for managing a record of a consumption process in which a plurality of users including a first user and a second user consume a resource with an expiration limit, the device comprising:
storage that stores first transaction data into the distributed ledger when the first user performs at least one of (i) consuming a first amount of a resource out of a predetermined amount of a resource with an expiration limit or (ii) handing a second amount of a resource out of the predetermined amount of the resource over to the second user, the first transaction data including a record of the at least one of the consumption and the handover by the first user;
a calculator that when a loss of the resource is found, calculates a retention period by referring to the distributed ledger, the loss of the resource being a remaining amount of a resource left unconsumed by the plurality of users upon the expiration limit out of the predetermined amount of the resource, the retention period indicating a period for which the first user has held the resource; and
an outputter that calculates a retention value of the first user based on the retention period, and outputs the retention value calculated, the retention value being included in a retention index which is an index indicating involvement in retention of the resource.

14. A non-transitory computer-readable recording medium having stored thereon a program for causing a computer to execute the management method according to claim 1.
